(19) United States
(12) Patent Application Publication
(10) Pub. No.: US 2004/0169769 A1
(43) Pub. Date: Sep. 2, 2004

(54) Digital camera and photographing display for displaying images

(75) Inventor: Hisashi Tatamiya, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/777,066

(22) Filed: Feb. 13, 2004

(30) Foreign Application Priority Data
Feb. 14, 2003 (JP) P2003-036865

(51) Int. Cl. H04N 5/222

(52) U.S. Cl. 348/370

(57) ABSTRACT

In a digital still camera body, a liquid crystal display (LCD) panel displays images at both the front and rear of the camera, is provided. In addition, a front back-light attaching space, and a rear back-light attaching space are also formed to attach a back-light unit. To display a subject image as a non-inverted image seen from the rear side, the back-light unit is attached in the front back-light attaching space. On the other hand, to display a subject image as a right to left inverted image seen from the front side, the back-light unit is attached in the rear back-light attaching space.

### BACKGROUND OF THE INVENTION

1. Field of the Invention

The present invention relates to image display of digital cameras, and cellular phones with photographing functions, and so on, especially, it relates to an image display for confirming a photographing area and a design of photograph.

2. Description of the Related Art

Conventionally, digital cameras can display subject images to confirm the photographing area and design before photographing. Especially, there is known a camera that can rotate its display panel, attached on the backside of the camera, by 180 degrees to confirm an image of a user when the user takes his photograph while holding the camera. In this case, when viewing the panel from a subject side, the image of the user is right to left inverted with signal process and is shown as mirror image. Typically, that is what the user has been used to seeing.

To properly confirm an image from the subject side, a camera mechanism must be complex because a rotating member for rotating a liquid crystal display, a switch to invert the image right to left, and signal process for the right to left inversion are required.

### SUMMARY OF THE INVENTION

Therefore, an objective of the present invention is to provide a digital camera, a photographing display, and so forth that can display an image as it is when the display is seen from a user side, that can show a mirror image when the display is seen from the subject side, and that has a simple structure.

A digital camera according to the present invention is a digital still camera, or a digital movie camera that can display an image when photographing. The camera has a camera body, a photographing optical system, a lighting unit, and a liquid crystal display (LCD) panel. The photographing optical system forms subject images. The lighting unit has a light-source device that emits light in a predetermined direction. The LCD panel selectively transmits light from the light-source device to display an image formed by a photographing optical system. The digital camera has a first space in the front side of the camera body, and a second space in the rear side of the camera body. The lighting unit is attached to the camera body, being selectively arranged in one of the first space and the second space. And when the lighting unit is arranged in the first space, the LCD panel selectively transmits light from the light-source device to display a non-inverted image so as to be seen from the rear side of the digital camera. A non-inverted image means an image as seen through a viewfinder, without right to left, or up to down inversion. On the other hand, when the lighting unit is arranged in the second space, the LCD panel displays a mirror image of a subject so as to be seen from the front side of the camera.

A digital camera body according to the present invention includes a photographing optical system and an LCD panel. The LCD panel selectively transmits light emitted by a lighting unit including a light-source device to display an image formed by the photographing optical system. The digital camera body has a first space and a second space to attach the light-source device at the front side of the LCD panel or at the rear of the LCD panel. The lighting unit is detachably attached in one of the first space and the second space for the light-source device so as to be arranged in one of the first space and the second space selectively. The LCD panel transmits light emitted by the lighting unit to display a non-inverted image that is viewed from the rear side of the LCD panel.

A lighting unit according to the present invention is detachably attached to the digital camera body. The lighting unit includes a light-source device that emits light, and a light leading member that leads light emitted by the light-source device to radiate in a predetermined direction.

A digital camera according to another aspect of the present invention, has a photographing optical system that forms a subject image, a lighting unit including a light-source device that emits light in a predetermined direction, and an LCD panel that selectively transmits light from the lighting unit to display a subject image. The LCD panel is arranged in a digital camera body so that a first panel surface faces a front side of the digital camera and a second panel surface located at the opposite side of the first panel surface, faces a rear side of the digital camera. The lighting unit is attached to the digital camera body so that the light-source device is selectively arranged at one of the first panel surface side and the second panel surface side, and the LCD panel transmits light to display a non-inverted image that is viewed from the rear side of the digital camera.

A digital camera body according to another aspect of the present invention, has a photographing optical system that forms a subject image, a lighting unit including a light-source device that emits light in a predetermined direction, and an LCD panel that selectively transmits light from the lighting unit to display a subject image. The LCD panel is arranged so that a first panel surface faces a front direction of the digital camera and a second panel surface located at the opposite side of the first panel surface, faces in a rear direction of the digital camera. The lighting unit is detachably attached so that the light-source device is selectively arranged at one of the first panel surface side and the second panel surface side, and the LCD panel transmits light to display a non-inverted image that is viewed from the rear of the digital camera.

A lighting unit according to another aspect of the present invention, is detachably attached to a digital camera body includes a light-source-device that emits light and a light leading member that leads light emitted by the light-source device in a predetermined direction.

A photographing display according to the present invention can be applied to digital cameras and cellular phones with photographing functions. The photographing display includes a light-source device that emits light and a light modulator unit. The light modulator unit has a first surface facing a first side, a subject side, and a second surface facing an opposite side of the first side. And the light modulator unit transmits light emitted by the light-source device selectively from the first surface to the second surface, or from the second surface to the first surface to display a subject image formed by a photographing optical system. The light-source device is selectively arranged at either the side of the first or the second surface, and the light modulator unit transmits light to display a non-inverted image, when the image is seen from the second side.

A method for displaying a photograph image, according to the present invention, includes a first step that emits light in a predetermined direction, a second step that arranges a light-source device for emitting light. In the second step, a user selectively arranges the light-source device in a first side or a second side in a light modulator unit that has a first surface facing the first side, which is a subject side, and a second surface facing the second side, which is an opposite side of the first side. The light modulator unit can selectively transmit light emitted by the light-source device from the first surface to the second surface, or from the second surface to the first surface to display a subject image formed by a photographing optical system. The method also includes a third step that transmits light emitted by the light-source device to display a non-inverted image when the image is viewed from the second side.

A digital camera according to another aspect of the present invention, includes a camera body, a photographing optical system that forms a subject image, a plate-shaped lighting unit including a light-source device that emits light in a predetermined direction, and an LCD panel that selectively transmits light from the plate-shaped lighting unit to display a subject image. The camera body has a first space to attach the plate-shaped lighting unit in the front of the LCD panel and a second space to attach the plate-shaped lighting unit at the rear of the LCD panel. The LCD panel transmits light from the plate-shaped lighting unit to display a non-inverted image that is viewed from the rear side of the digital camera.

A digital camera according to another aspect of the present invention, includes a camera body, a photographing optical system that forms a subject image, a U-shaped lighting unit including a light-source device that emits light in a predetermined direction, and an LCD panel that selectively transmits light from the U-shaped lighting unit to display a subject image. The camera body has a first space and a second space that are connected from a camera front side to a camera rear side, and the light-source device is provided in one of the two bar-shaped members of the U-shaped lighting unit, and the U-shaped lighting unit is selectively and detachably attached to the first space and the second space that are connected so that the light-source device is arranged in the first space and the second space. The LCD panel transmits light from the U-shaped lighting unit to display a non-inverted image that is viewed from the rear side of the digital camera.

### BRIEF DESCRIPTION OF THE DRAWINGS

The present invention will be better understood from the description of the preferred embodiment of the invention set forth below together with the accompanying drawings, in which:

FIG. 1 is a front view of a digital still camera of the first embodiment of the present invention;

FIG. 2 is a rear view of the digital still camera;

FIG. 3 is a front view of a back-light unit;

FIG. 4 is a plan view of the top side of the back-light unit;

FIG. 5 is a side plan view of the camera body;

FIG. 6 is a side plan view of the back-light unit;

FIG. 7A is a plan view of the top side of the back-light unit;

FIG. 7B is a bottom view of the camera body without the back-light unit;

FIG. 8 is a section view of the back-light unit;

FIG. 9 is a section view of the camera body without the back-light unit;

FIG. 10 is a rear view of the digital still camera showing an image on the rear surface;

FIG. 11 is a side plan view of the digital still camera where the back-light unit is attached in the front back-light attaching space;

FIG. 12 is a front view of the digital still camera showing an image on the front surface;

FIG. 13 is a side plan view of the digital still camera where the back-light unit is attached in the rear back-light attaching space;

FIG. 14 is a front view of a digital still camera body of the second embodiment;

FIG. 15 is a rear view of the camera body;

FIG. 16 is a plan view of the back light unit;

FIG. 17 is a bottom view of the digital still camera;

FIG. 18 is a left side plan view of the camera body;

FIG. 19 is a side plan view of the back-light unit;

FIG. 20 is a sectional view of the back-light unit;

FIG. 21 is a sectional view of the back-light unit differing from that in FIG. 20;

FIG. 22 is a sectional view of the back-light unit differing from that in FIG. 20 and FIG. 21;

FIG. 23 is a side plan view of the digital still camera attaching the back-light unit;

FIG. 24 is a rear view of the digital still camera showing an image;

FIG. 25 is a side plan view of the digital still camera attaching the back-light unit; and

FIG. 26 is a front view of the digital still camera showing an image.

### DESCRIPTION OF THE PREFERRED EMBODIMENTS

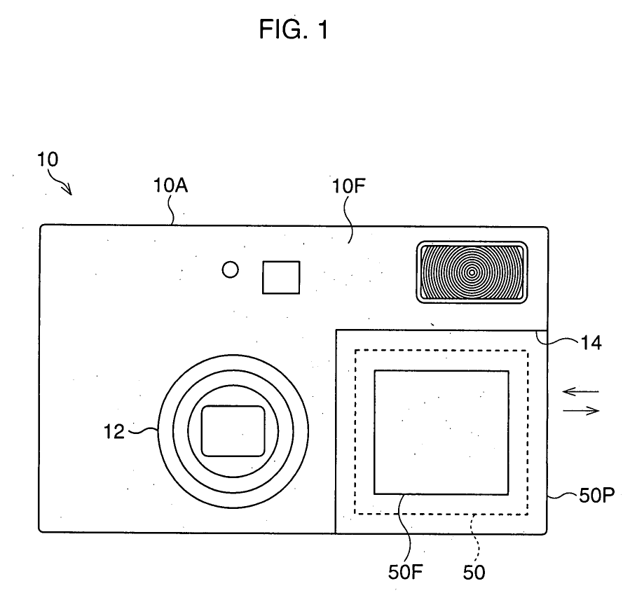

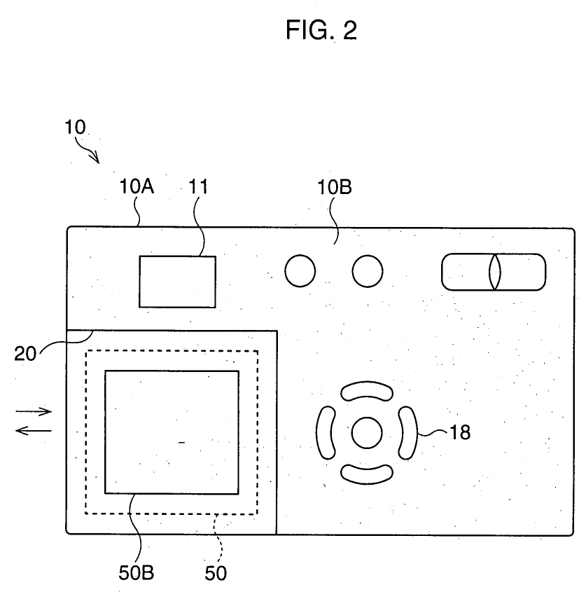

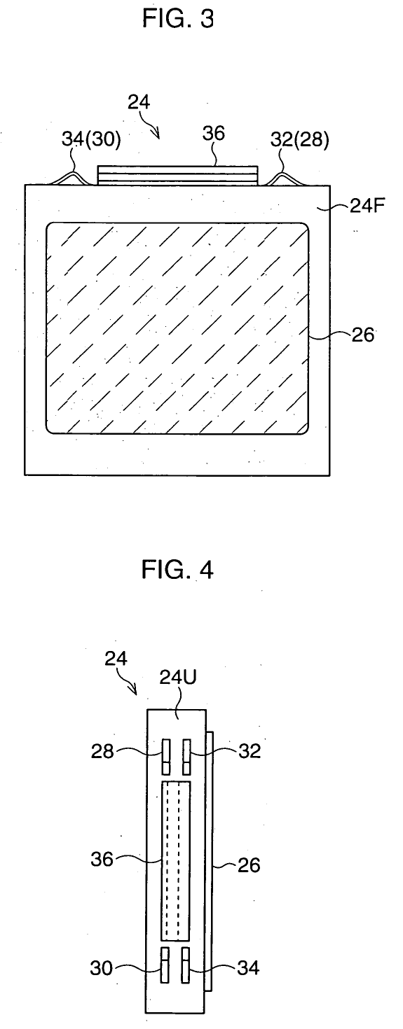

Hereinafter, the preferred embodiments of the present invention are described with reference to the attached drawings. FIG. 1 is a front view of a digital still camera of the first embodiment of the present invention. FIG. 2 is a rear view of the digital still camera. FIG. 3 is a front view of a back-light unit, and FIG. 4 is a plan view of the back-light unit.

A digital still camera 10 can display a moving image in photographing mode, and can display a recorded image in the replay mode. The digital still camera 10 has a liquid crystal display (LCD) panel 50 and a back-light unit 24 that is detachably attached to the camera body 10A. In FIG. 1 and FIG. 2, the digital still camera without the back-light unit 24 is shown. In the front surface of the digital still camera 10F, a front back-light attaching space 14, that is a space for attaching the back-light unit 24 close to a lens barrel 12, is formed (see FIG. 1). When the back-light unit 24 is attached in the front back-light attaching space 14, the back-light unit 24 is attached and removed in the directions indicated by the arrow. On the other hand, in the rear surface of the digital still camera 10B, the same side as the finder 11 and the setting button 18, a rear back-light attaching space 20 for attaching the back-light unit 24 is formed (see FIG. 2). When the back-light unit 24 is attached in the rear back-light attaching space 20, the back-light unit 24 is attached and removed in the directions indicated by the arrow in FIG. 2. The back-light unit 24 is attached in the front back-light attaching space 14 or the rear back-light attaching space 20 selectively for required.

An LCD panel 50 is formed in a plate-shaped member 50P between the front back-light attaching space 14 and the rear back-light attaching space 20. A front side display panel 50F is formed in the front surface 10F, and a rear side display panel 50B is formed in the rear surface 10B.

On the front surface 24F of the back-light unit 24, a light-emitting surface 26, in which radiated light passes through, is formed (see FIG. 3). In the top of the back-light unit 24U, a first back-light electric connection 28, a second back-light electric connection 30, a first GND connecting point 32, and a second GND connecting point 34 are formed to supply electric power to the back-light unit 24. In addition, a guide-rail 36 for connection to the camera body 10A is formed in the top surface 24U of the back-light unit 24 (see FIG. 4). The first back-light electric connection 28 and the first GND connecting point 32 are arranged close to each other and make a pair, as do the second back-light electric connection 30 and the second GND connecting point 34 (see FIG. 4).

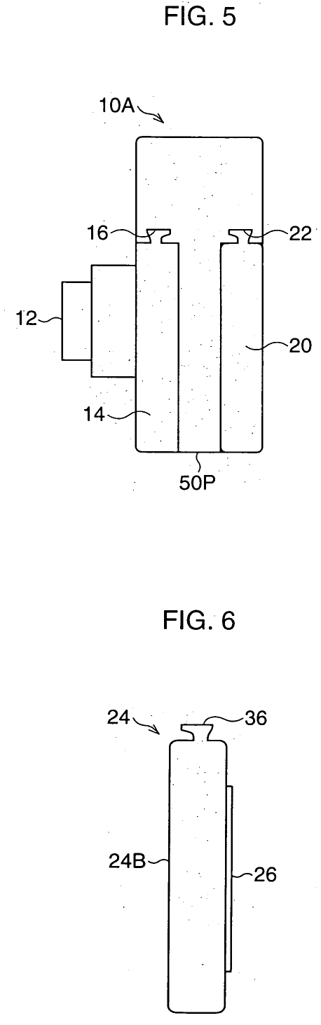

FIG. 5 is a side plan view of the camera body 10A and FIG. 6 is a side plan view of the back-light unit 24. Note that, in FIG. 5, the camera body 10A is shown in a state where no back-light unit 24 is attached in the front back-light attaching space 14, nor the rear back-light attaching space 20.

In the top of the front back-light attaching space 14, a front groove 16 is formed to determine the direction in which the guide rail 36 of the back-light unit 24 is attached. Similar to the front back-light attaching space 14, in the top of the rear back-light attaching space 20, a back groove 22 is formed for the same reason as the front groove 16. The sizes of the front back-light attaching space 14 and the rear back-light attaching space 20, both correspond to the size of the back-light unit 24. When the back-light unit 24 is attached to the camera body 10A, the rear surface of the back-light unit 24B, becomes part of the front surface 10F, or the rear surface 10B. The sectional shape of the guide rail 36 is designed to slidably move along the front groove 16 or the back groove 22. When a user inserts the back-light unit 24 into the front back-light attaching space 14 or the rear back-light attaching space 20, the guide rail 36 slides along the front groove 16 or the back groove 22. The sectional shape of the guide rail 36 is designed to be asymmetrical from right to left, and the front groove 16 and the back groove 22 are also designed to correspond to the asymmetrical shape of the guide rail 36. Therefore, the insertion directions of the back-light unit 24 into the front back-light attaching space 14 or the rear back-light attaching space 20 are determined by the front groove 16 and the back groove 22 respectively.

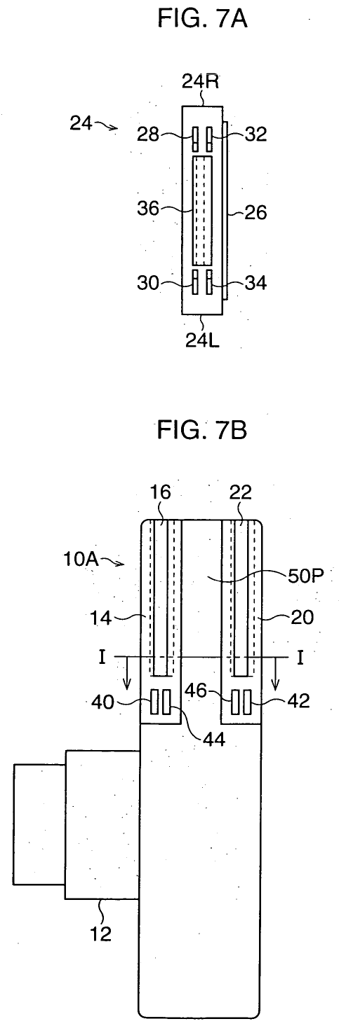

FIG. 7A is a plan view of the top of the back-light unit 24, and FIG. 7B is a view of the bottom side of the camera body 10A without the back-light unit 24.

In the top surface of the front back-light attaching space 14, a first electric connection 40 and a first GND 44 are formed in a pair, and in the upper surface of the rear back-light attaching space 20, a second electric connection 42 and a second GND 46 are formed in a pair. As mentioned above, insertion directions of the back-light unit 24 into the front back-light attaching space 14 and the rear back-light attaching space 20 are both determined, so that the light-emitting surface 26 faces the inside of the digital still camera 10 from both the front back-light attaching space 14 and the rear back-light attaching space 20. That is when the back-light unit 24 is inserted into the front back-light attaching space 14, the right side 24R of the back-light unit 24 is inserted furthest into, the camera body 10A, the first back-light electric connection 28 is connected to the first electric connection 40, and the first GND connecting point 32 is connected to the first GND 44. On the other hand, when the back-light unit 24 is inserted into the rear back-light attaching space 20, the left side 24L of the back-light unit 24 is inserted furthest into the camera body 10A, the second back-light electric connection 30 is connected to the second electric connection 42, and the second GND connecting point 34 is connected to the second GND 46. As a result, electric power is supplied to the-back-light unit 24 by the digital still camera 10.

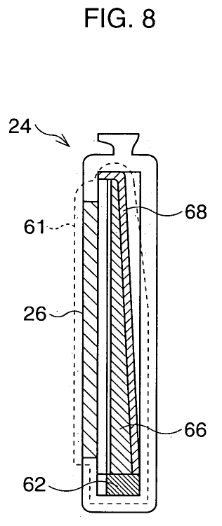

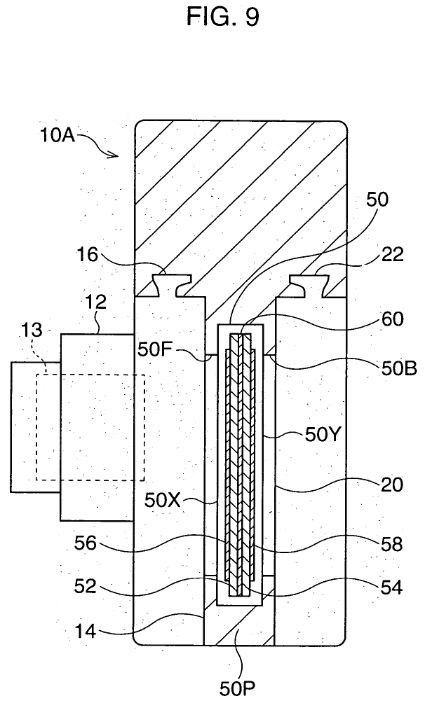

FIG. 8 is a section view of the back-light unit 24 and FIG. 9 is a section view of the camera body 10A, without the back-light unit 24, taken along a line I-I of FIG. 7.

A light-source device 61, provided in the back-light unit 24, has a white LED light source 62, a light leading plate 66, a metal plate 68, and a light-emitting surface 26. When electric power is supplied to the back-light unit 24, the LED light source 62 emits light, and the light is led to the entire light-emitting surface 26 by the light leading plate 66 and the metal plate 68. As a result, the light is emitted by the light-emitting surface 26 equally.

The LCD panel 50 includes a first polarizing plate 56, a first glass plate 52, a liquid crystal 60, a second glass plate 54, and a second polarizing plate 58. A matrix type RGB color filter (not shown) is located in the first or second glass plate 52, 54. The LCD. panel 50 is driven by a driving circuit (not shown) in the camera body 10A. When a subject image captured by a photographing optical system 13 is formed in the CCD (not shown), image signals are read from the CCD, and the driving circuit drives the LCD panel 50 on the basis of the image signals. As a result, the LCD panel 50 selectively transmits light emitted by the back-light unit 24 to form the subject image.

The LCD panel 50 is symmetrical about the transparent liquid crystal 60. Therefore, when installing the back-light unit 24 in the rear back-light attaching space 20, a subject image can be observed from the front-side of the digital still camera 10 through a front panel surface 50X. On the other hand, the image can be observed from backside of the digital still camera 10 through a rear panel surface 50Y when installing the back-light unit 24 in the front back-light attaching space 14. That is, as mentioned below, when a user sees the LCD panel 50 from the backside of the digital still camera 10, a non-inverted image is observed (the same image as image that is observed through the finder 11), and when a user sees the LCD panel 50 from the front-side of the digital still camera 10, a mirror image that is right to left inverted is observed.

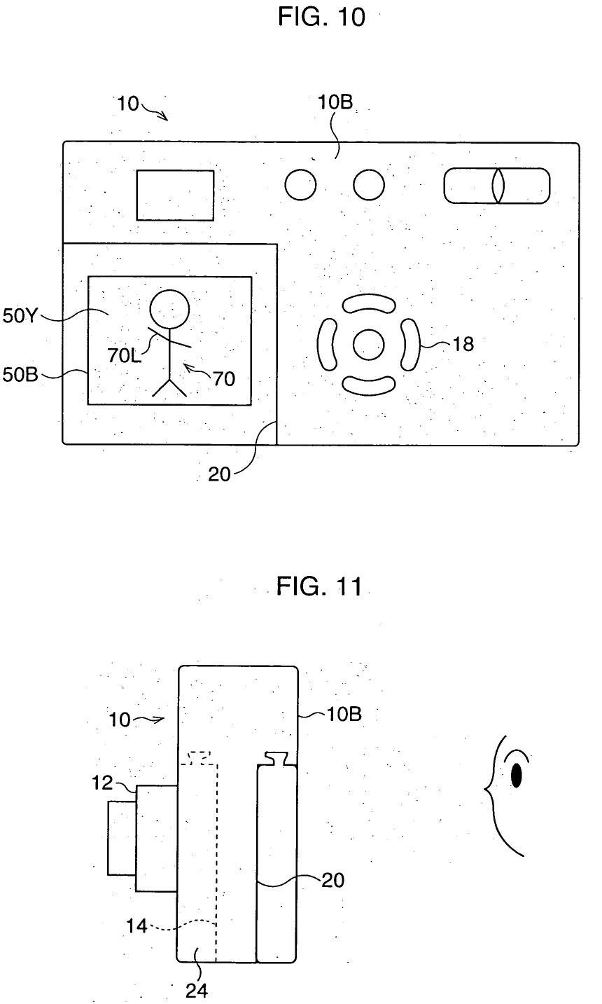

FIG. 10 is a rear view, showing an image on the rear surface 10B. FIG. 11 is a side plan view of the digital still camera 10 when the back-light unit 24 is attached in the front back-light attaching space 14.

When the back-light unit 24 is attached in the front back-light attaching space 14, an image 70 captured by the photographing optical system 13 is displayed on the rear panel surface 50Y. The image 70 can be observed from the rear side through the rear back-light attaching space 20. In this case, the image 70 captured by the photographing optical system 13 is observed as a non-inverted image. For example, when a subject person lifts his right hand, the image 70 is observed as having the hand 70L on the left side of the image, lifted (see FIG. 10).

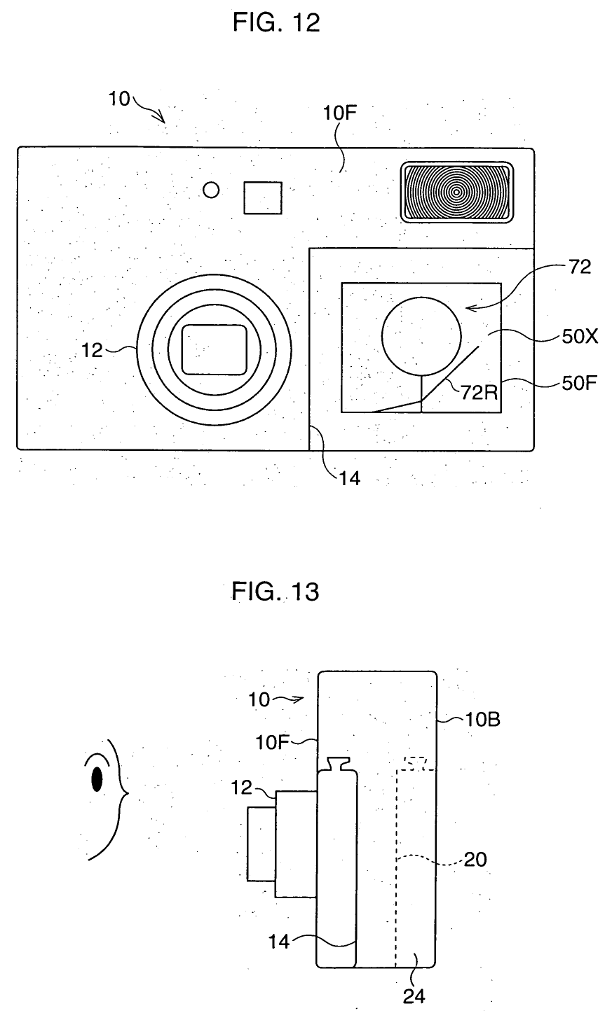

FIG. 12 shows an image on the front surface 10F. FIG. 13 is a side plan view of the digital still camera 10 where the back-light unit 24 is attached in the rear back-light attaching space 20.

When the back-light unit 24 is attached in the rear back-light attaching space 20, an image 72 captured by the photographing optical system 13 is displayed on the front panel surface 50X. The image 72 can be observed from the front side through the front back-light attaching space 14. In this case, the image 72 is observed as a right to left inverted image because the back-light unit 24 emits light from the rear surface 10B side. Therefore, when a user as a subject, lifts his right hand, the image 72 is observed as having the hand 72R on the right side of the image, lifted (see FIG. 12).

In the embodiment mentioned above, the LCD panel 50 is formed in the camera body 10A, and the front back-light attaching space 14, and the rear back-light attaching space 20 are formed in the front surface 10F side and the rear surface 10B side, respectively. The back-light unit 24 is attached to either the front back-light attaching space 14 or the rear back-light attaching space 20. A user can choose between a display on a subject side and on a rear (user) side by altering the position of the back-light unit 24, which can be attached at both the front and rear of the camera. When displaying an image on the rear surface, non-inverted image is observed. On the other hand, when a user selects a display on a subject side, a mirror image of the subject is displayed without inversion.

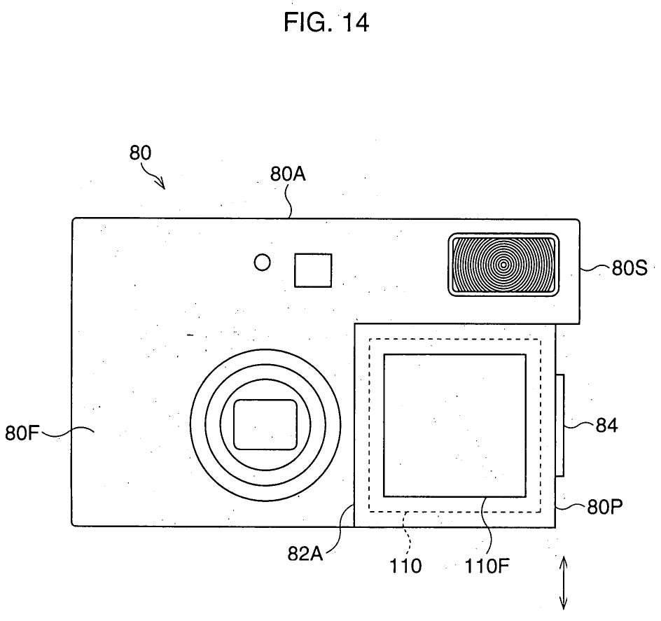

Hereinafter, the second embodiment of the present invention is described with reference to the attached FIGS. 14 to 26. In this embodiment, the back-light unit is different from that in the first embodiment. In this embodiment, a U-shaped back-light unit is detachably attached to the camera body 10.

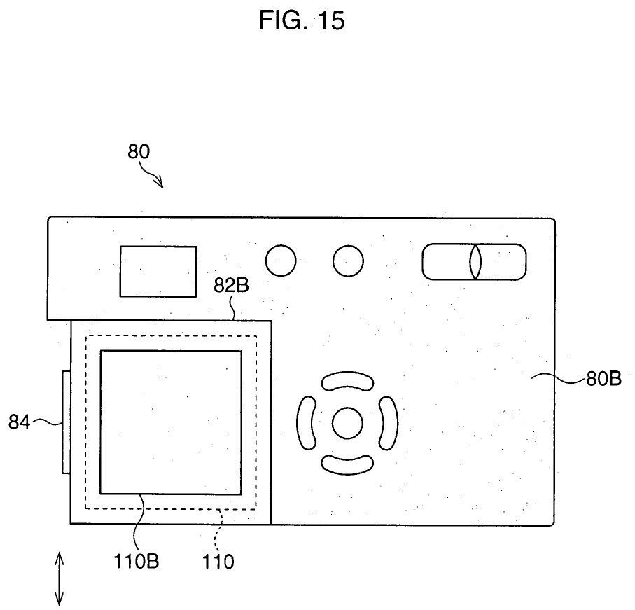

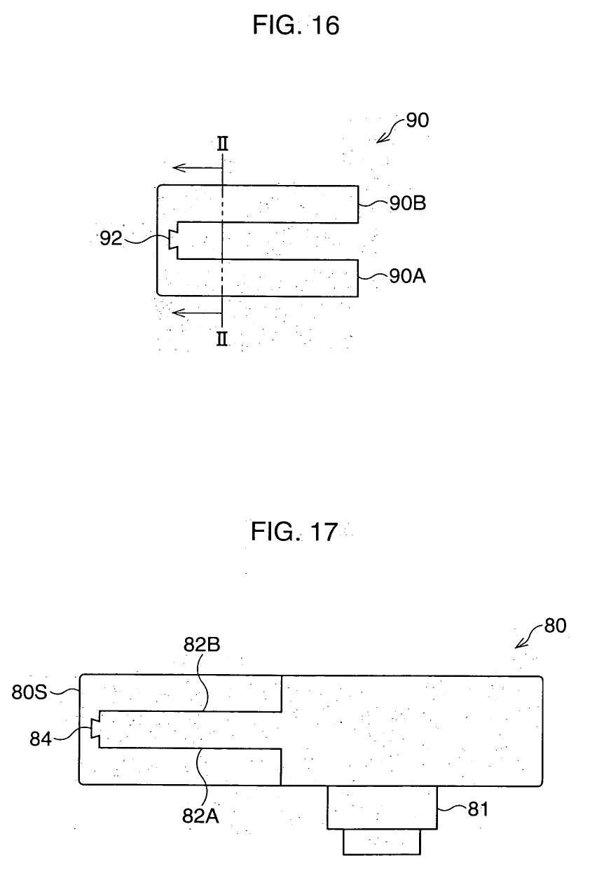

FIG. 14 is a front view of a digital still camera body 80A of the second embodiment. FIG. 15 is a rear view of the camera body 80A. FIG. 16 is a plan view of the back light unit 90, and FIG. 17 is a bottom side view of the digital still camera 80.

In a plate-shaped member 80P of the camera body 80A, an LCD panel 110 is formed. In the LCD panel 110, a front side display panel 110F is formed on the front surface 80F, and a rear side display panel 110B is formed on the rear surface 80B. In the front surface of the digital still camera 80F, a front back-light attaching space 82A which is a space for attaching the U-shaped back-light unit 90 is provided, and on the rear surface of the digital still camera 80B, a rear back-light attaching space 82B for attaching the back-light unit 90 is also provided. The front back-light attaching space 82A and the rear back-light attaching space 82B are forming a single space by connecting to each other. The size and shape of the front back-light attaching space 82A and the rear back-light attaching space 82B, correspond to the size and shape of the back-light unit 90.

When the back-light unit 90 is attached to the camera body 80A, the surfaces of the back-light unit 24B become part of the front surface 10F, the rear surface 10B, and the side surface of the digital still camera 80 (see FIG. 17). A guide rail 84 is formed in a direction parallel to the left side surface 80S of the digital still camera 80. In the back-light unit 90, a back-light unit insertion groove 92 is formed. The sectional shape of the back-light unit insertion groove 92 is designed to allow it to slide in the guide rail 84. Therefore, the back-light unit 90 is attached and removed in the directions indicated by the arrows. (see FIG. 14 and FIG. 15).

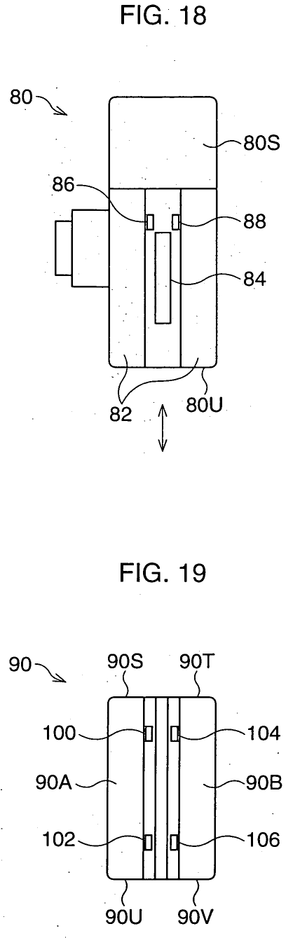

FIG. 18 is a left side plan view of the camera body 80A and FIG. 19 is a side plan view of the back-light unit 90.

The guide rail 84 has a symmetrical-shape differing from the guide rail 36 in the first embodiment. Therefore, when the U-shaped back-light unit 90 has two bar-shaped members, the first back-light unit member 90A and the second back-light unit member 90B, which extend either side of the back-light unit insertion groove 92 (see FIG. 16 and FIG. 19), both members 90A and 90B can be attached in the front back-light attaching space 82A and the rear back-light attaching space 82B.

A first back-light connecting point 100 is formed on an upper portion of the first back-light unit member 90A, and a second back-light connecting point 102 is formed on a lower portion of the first back-light unit member 90A. Similarly to the first back-light unit member 90A, a third back-light connecting point 104 is formed on an upper portion of the second back-light unit member 90B, and a forth back-light connecting point 106 is formed on an lower portion of the second back-light unit member 90B. When the back-light unit 90 is attached so that its lower surface 90U and lower surface 90V become parts of the bottom surface 80U of the digital still camera 80, the first back-light connecting point 100 and the third back-light connecting point 104 are respectively connected to a first camera connecting point 86 and a second camera connecting point 88 both formed in the camera body 80A. On the other hand, when the back-light unit 90 is attached so that its upper surface 90S and upper surface 90T become parts of the bottom surface 80U of the digital still camera 80, the second back-light connecting point 102 and the fourth back-light connecting point 106 are respectively connected to the first camera connecting point 86 and the second camera connecting point 88. The back-light unit 90 is supplied with electric power from the digital still camera 80 due to connections between these points. The back-light unit 90 is supported by a stopper spring (not shown) arranged in the camera body 80A while the back-light unit is attached to the camera body 80A. The back-light unit 90 is removed from the camera body 80A with an operation of a lever (not shown).

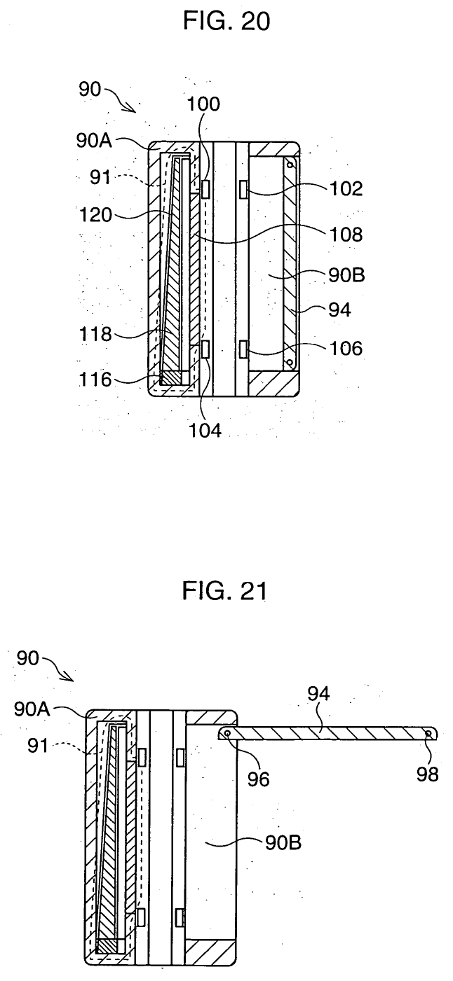

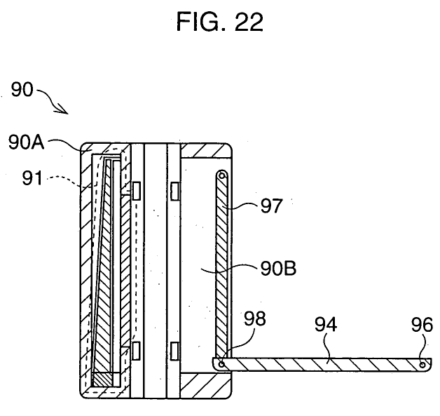

FIG. 20, FIG. 21 and FIG. 22 are sectional views of the back-light unit 90 taken along a line II-II of FIG. 16.

Alight-source device 91 including a white LED light source 116, a light-emitting surface 108, a light leading plate 118, and a metal plate 120, are formed in the first back-light unit member 90A (see FIG. 20). The light emitted by the light source 116 is led to the entire light-emitting surface 108 by the light leading plate 118. On the other hand, in the second back-light unit member 90B, a back-light unit hood 94 is formed to intercept the light. The back-light unit hood 94 has a so-called double hinge structure with a first rotation center axis 96, a second rotation center axis 98, and an arm 97. Therefore, the back-light unit hood 94 can rotate about both the first rotation center axis 96 and the second rotation center axis 98 (see FIG. 21 and FIG. 22).

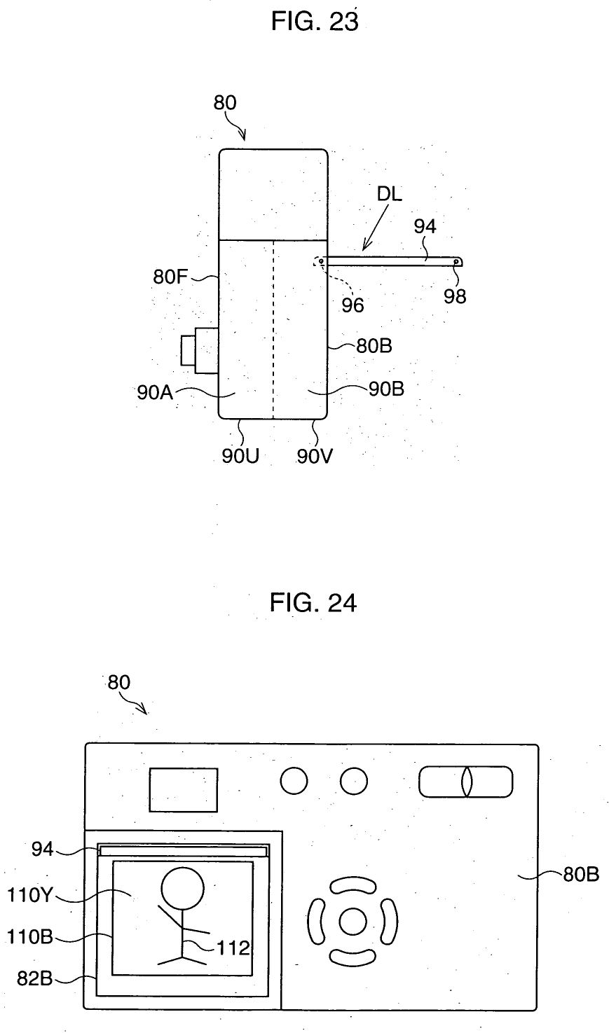

FIG. 23 is a side plan view of the digital still camera 80, where the first back-light unit member 90A of the back-light unit 90 is located at the front surface 80F side. FIG. 24 is a rear view of the digital still camera 80 showing an image in this state.

In the case where the first back-light unit part 90A of the back-light unit 90 is attached in the front back-light attaching space 82A, light is emitted by the light-emitting surface 108 inside the back-light unit 90, and the back-light unit hood 94 opens by rotating about the first rotation center axis 96 at the same time. As a result, light is emitted from the first back-light unit member 90A to the rear surface 80B, then an image 112 shown on a rear panel surface 110Y of the LCD panel 110 is observed by a user through the rear display panel 110B and the rear back-light attaching space 82B at the rear surface 80B (see FIG. 24). Natural light radiated to the LCD panel 110 is intercepted by the back-light unit hood 94, therefore, good visibility is possible for the user (see FIG. 23).

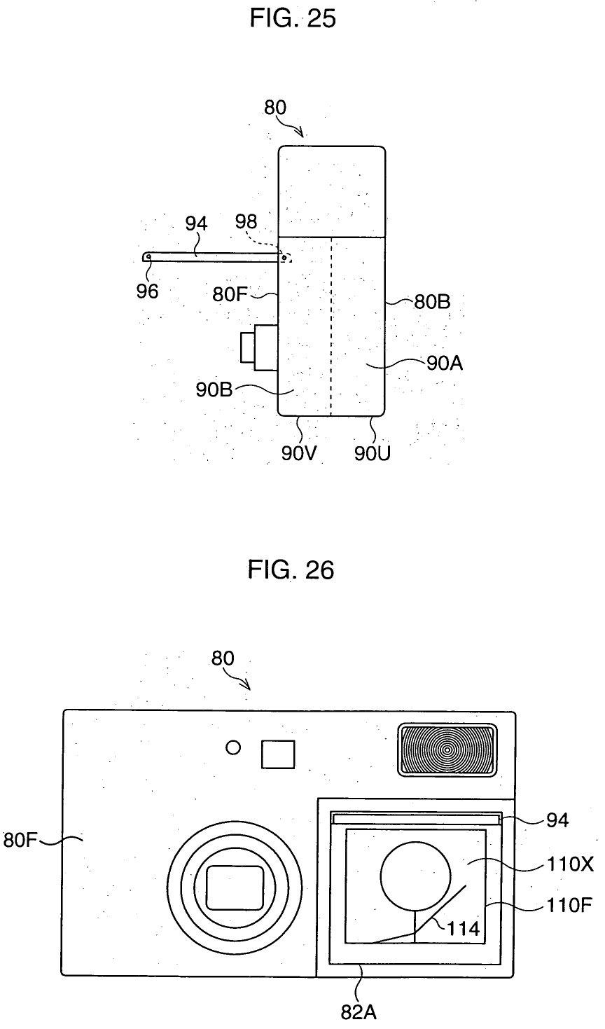

FIG. 25 is a side plan view of the digital still camera 80 where the first back-light unit member 90A of the back-light unit 90 is located at the rear surface 80B side. FIG. 26 is a front view of the digital still camera 80 showing an image at this time.

In a case where the first back-light unit part 90A of the back-light unit 90 is located in the rear back-light attaching space 82B, light is emitted by the light-emitting surface 108 inside the back-light unit 90, and the back-light unit hood 94 opens by rotating about the second rotation center axis 98 at the same time. As a result, light is emitted from the first back-light unit member 90A to the front surface 80F, then an image 114 shown on a front panel surface 110X of the LCD panel 110 is observed by a user through the front side display panel 110F and the front back-light attaching space 82A at the front surface 80F (see FIG. 26).

In the second embodiment mentioned above, the back-light unit 90 is detachably attached to the camera body 80A. Therefore, a user can hold and operate the digital still camera 80 in the same way as usual cameras.

Note that, using a colorless and transparent glass plate instead of the back-light unit hood 94 in the second back-light unit member 90B of the back-light unit 90, is also possible.

Back-light units that are not plate-shaped can be used, although plate-shaped back-light units 24 and 90 are used in both the first and second embodiment.

Although light is emitted in one direction from light sources 62 and 116 via light-emitting surfaces 26 and 108, the back-light units 24 and 90 can be designed to emit light in any direction.

Although each of the back-light units 24 and 90 is attached and removed in one predetermined direction, they can move in other directions.

The back-light units 24 and 90 can be designed to move from the front back-light attaching space 14 and 82A, to the rear back-light attaching space 20 and 82B or vice versa selectively after being attached to the camera body 10A or 80A, although in the above embodiments, they are set in the desirable space by a user. In this case, the back-light unit 24 and 90 can be designed to move automatically.

Although images are shown by the LCD panels 50 and 110 using back-light units 24 and 90 in both of the embodiments, other light modulator units that transmit light selectively can be applied instead of these LCD panels 50 and 110.

Although both embodiments show the digital still cameras 10 and 80 with display units, the present invention can be applied to digital movie cameras, film cameras with display equipment, and cellular phones with photographing functions for example.

As mentioned above, the invention enables photographing equipment with display functions that can show an image as captured when a display panel is seen from the rear (a user side), and that can show a mirror image when a display panel is seen from a subject side.

Finally, it will be understood by those skilled in the art that the foregoing description is of preferred embodiments of the device, and that various changes and modifications may be made to the present invention without departing from the spirit and scope thereof.

The present disclosure relates to subject matters contained in Japanese Patent Application No. 2003-036865 (filed on Feb. 14, 2003) which is expressly incorporated herein, by reference, in its entirety.

1. A digital camera comprising;
a camera body;
a photographing optical system that forms a subject image;
a lighting unit including a light-source device that emits light in a predetermined direction; and
a liquid crystal display (LCD) panel that selectively transmits light emitted by said light-source device to display said subject image;
wherein the camera body has a first space to attach said light-source device in front of said LCD panel and a second space to attach said light-source device at the rear of said LCD panel, and said LCD panel transmits light so as to display a non-inverted image when viewed from the rear side of said digital camera.

2. The digital camera according to claim 1, wherein said lighting unit is shaped to be attached in said first space and said second space, said lighting unit being detachably and manually attached in one of said first space and said second space.

3. The digital camera according to claim 1, wherein said lighting unit is shaped to be attached in a single space comprising said first space and said second space, said lighting unit being detachably and manually attached to said camera body.

4. The digital camera according to claim 3, wherein said lighting unit is U-shaped, and said light-source device is provided in one of the two bar-shaped members of said U-shaped lighting unit, and said one of the two bar-shaped members is attached in said first space or said second space selectively, and another bar-shaped member is attached in one of said first space or said second space that said one of the two bar-shaped members is not attached in.

5. The digital camera according to claim 2, wherein said camera body has leading grooves that run along a line from a left side surface to a right side surface of said digital camera and that determine the direction in which said lighting unit is attached, and said lighting unit has a guide rail that slides along and engages with said leading grooves.

6. The digital camera according to claim 3, wherein said camera body has a guide rail that runs along a line from the top surface to the bottom surface of said digital camera and that determines the direction in which said lighting unit is attached, and said lighting unit has a leading groove that slides along and engages with said guide rail.

7. The digital camera according to claim 5, wherein said camera body has body-side electric connecting points arranged along said leading grooves to supply electric power to said lighting unit, and said lighting unit has unit-side electric connecting points arranged along said guide rail to connect to said body-side electric connecting points.

8. The digital camera according to claim 6, wherein said camera body has body-side electric connecting points arranged along said guide rail to supply electric power to said lighting unit, and said lighting unit has unit-side electric connecting points arranged along said leading groove to connect to said body-side electric connecting points.

9. The digital camera according to claim 5, wherein said light-source device has a light-emitting surface that emits light in a predetermined direction, and said leading grooves have asymmetrical shapes from right to left for said lighting unit to be attached so that said light-emitting surface faces said LCD panel.

10. The digital camera according to claim 6, wherein said light-source device has a light-emitting surface that emits light in a predetermined direction, and said leading groove has a symmetrical shape from right to left for said lighting unit to be attached so that said light-emitting surface faces said LCD panel.

11. The digital camera according to claim 1, wherein said light-source device has a light-emitting surface that emits light in a predetermined direction, and said light-source device is selectively arranged in one of said first space and said second space for said lighting unit to be attached so that said light-emitting surface faces said LCD panel.

12. A digital camera body comprising;
a photographing optical system that forms a subject image; and
an LCD panel that selectively transmits light emitted by a lighting unit including a light-source device to display said subject image;
wherein said camera body has a first space and a second space to attach said light-source device at the front side of said LCD panel or at the rear of said LCD panel, and said lighting unit is detachably attached in one of said first space and said second space for said light-source device so as to be arranged in one of said first space and said second space selectively, and said LCD panel transmits light-emitted by said lighting unit to display a non-inverted image when viewed from the rear of said LCD panel.

13. A lighting unit that is detachably attached to the digital camera body described in claim 12, comprising;
a light-source device that-emits light; and
a light leading member that leads light emitted by said light-source device to radiate in a predetermined direction.

14. A digital camera comprising;
a photographing optical system that forms a subject image;
a lighting unit including a light-source device that emits light in a predetermined direction; and
an LCD panel that selectively transmits light from said lighting unit to display said subject image, and that is arranged in a digital camera body so that a first panel surface faces a front side of said camera and a second panel surface located at the opposite side of said first panel surface, faces a rear side of said camera;
wherein said lighting unit is attached to said camera body so that said light-source device is selectively arranged at one of said first panel surface side and said second panel surface side, and said LCD panel transmits light to display a non-inverted image when viewed from the rear of said digital camera.

15. A digital camera body comprising;
a photographing optical system that forms a subject image;
a lighting unit including a light-source device that emits light in a predetermined direction; and
an LCD panel that selectively transmits light from said lighting unit to display said subject image, and that is arranged so that a first panel surface faces a front direction of said camera and a second panel surface located at the opposite side of said first panel surface, faces in a rear direction of said camera;
wherein said lighting unit is detachably attached so that said light-source device is selectively arranged at one of said first panel surface side and said second panel surface side, and said LCD panel transmits light to display a non-inverted image when viewed from the rear of said digital camera.

16. A lighting unit that is detachably attached to a digital camera body described in claim 15 comprising;
a light-source device that emits light; and
a light leading member that leads light emitted by said light-source device in a predetermined direction.

17. A photographing display apparatus comprising;
a light-source device that emits light;
a light modulator unit that has a first surface facing a first side which is a subject side and a second surface facing an opposite side of said first side, and that selectively transmits light emitted by said light-source device from said first surface to said second surface, or from said second surface to said first surface to display a subject image formed by a photographing optical system;
wherein said light-source device is selectively arranged in one of said first surface side and said second surface side, and said light modulator unit transmits light emitted by said light-source device to display a non-inverted image when viewed from said second side.

18. A method for displaying a photograph image comprising:
emitting light in a predetermined direction;
arranging a light-source device for emitting light, selectively in one of a first side and a second side of a light modulator unit that has a first surface facing said first side which is a subject sideband a second surface facing said second side which is an opposite side of said first side, and that selectively transmits light emitted by said light-source device from said first surface to said second surface, or from said second surface to said first surface to display a subject image formed by a photographing optical system; and
transmitting light emitted by said light-source device to display a non-inverted image when viewed from said second side.

19. A digital camera comprising;
a camera body;
a photographing optical system that forms a subject image;
a plate-shaped lighting unit including a light-source device that emits light in a predetermined direction; and
an LCD panel that selectively transmits light from said plate-shaped lighting unit to display said subject image;
wherein the camera body has a first space to attach said plate-shaped lighting unit in the front of said LCD panel and a second space to attach said plate-shaped lighting unit at the rear of said LCD panel, and said LCD panel transmits light from said plate-shaped lighting unit to display a non-inverted image when viewed from the rear side of said digital camera.

20. A digital camera comprising;
a camera body;
a photographing optical system that forms a subject image;
a U-shaped lighting unit including a light-source device that emits light in a predetermined direction; and
an LCD panel that selectively transmits light from said U-shaped lighting unit to display said subject image;
wherein the camera body has a first space and a second space that are connected from a camera front side to a camera rear side, and said light-source device is formed in one of two bar-shaped members of said U-shaped lighting unit, and said U-shaped lighting unit is selectively and detachably attached to said first space and said second space that are connected so that said light-source device is arranged in said first space and said second space, and said LCD panel transmits light from said U-shaped lighting unit to display a non-inverted image when viewed from the rear side of said digital camera.
